(19) United States
(12) Patent Application Publication
(10) Pub. No.: US 2022/0316251 A1
(43) Pub. Date: Oct. 6, 2022

(54) A SLIDING SYSTEM

(71) Applicant: ÇEMOBSAN METAL VE PLASTIK SANAYI TICARET LIMITED SIRKETI, Tekirdag (TR)

(72) Inventors: Emre ARAT, Tekirdag (TR); Kubilay ÖZYALÇIN, Tekirdag (TR); Haluk BÜYÜKYILDIRIM, Tekirdag (TR)

(21) Appl. No.: 17/634,336

(22) PCT Filed: Dec. 25, 2020
(86) PCT No.: PCT/TR2020/051393

§ 371 Date: Feb. 10, 2022

(30) Foreign Application Priority Data
Apr. 29, 2020 (TR) 2020/06695

(51) Int. Cl. E05D 15/06

(52) U.S. Cl. CPC E05D 15/0673

(57) ABSTRACT

A sliding system enabling furniture doors to slide on a rail mechanism configured on the base of the furniture in order to open horizontally and operating with a special side plastic with a concealed damper.

### TECHNICAL FIELD

The invention relates to a sliding system moving on the rail mechanisms configured to the furniture.

In particular, the invention relates to a sliding system enabling the furniture doors to slide on the rail mechanism configured on the base of the furniture in order to open horizontally and operating with a special side plastic with a hidden damper.

### PRIOR ART

Today, the sliding systems moving on the rail mechanisms are frequently used, particularly in the furniture business sector. Alongside with the sliding mechanisms that move on the rail, often there are equipments that slow down the cabinet door. The dampers are generally not fitted into the rail, or the fitted ones are located at visible points.

In the sliding systems used in the present technique, the damper cannot be added to the sliding mechanism in order to close the door slowly and maintain its position, or the dampers are integrated into the rail. Additional apparatus is required to drive the damper in the present types. Incorrect production or assembly of this apparatus also affects the damper's quality.

In conclusion, the problems mentioned above and that could not be solved in the light of the present technique has made it necessary to make an innovation in the related technical field.

### BRIEF DESCRIPTION OF THE INVENTION

The present invention relates to a sliding system in order to eliminate the above-mentioned disadvantages and to bring new advantages to the related technical field.

The main object of the invention is to provide a sliding system enabling the furniture doors to slide on the rail mechanism configured on the base of the furniture in order to open horizontally and operating with a special side plastic with a hidden damper.

Another object of the invention is to create a system and a method that can be driven by the damper apparatus hidden by the ends of the side plastics without the need for an extra apparatus and provide the damper's holder to be set by the adjustment made to the mechanism.

Another object of the invention is to form a system that is suitable for the side plastics and the built-in rails in order to use the hidden damper system in the sliding system and provides additions to be performed to hold the damper.

Another object of the invention is to present a system that prevents the use of separate apparatus by adding the damper counterpart to the end of the side plastics.

The present invention is the sliding system enabling furniture doors to move in a horizontal level and comprising the following to carry out all the purposes mentioned above and that will emerge from the detailed description below:
at least one rear base plate fixed to furniture doors,
at least one roller holder plate located on above stated rear base plate,
at least one roller enabling the furniture doors to open and close by sliding along a predetermined route,
at least one rivet enabling the centering and fixing of the above stated roller(s),
a spring allowing the roller(s) carrying the load of furniture door to move back to their predetermined positions after releasing the load,
at least one screw keeping the rollers at a predetermined height to balance the load of the doors,
at least one nut enabling the above mentioned screw to be fixed,
locking plastic keeping the above mentioned roller(s) up for easing the assembly while fitting the furniture doors to the rail.

Accordingly, the system further comprises
at least one side unit that is placed in the rail where the furniture doors are set, compatible with the concealed damper invisible to the end user, in which the end parts are used as a counter to the damper and that prevents noise and abrasion caused by friction.

In order to understand the configuration of the present invention and its advantages together with the additional elements, it should be evaluated together with the drawings described below.

### BRIEF DESCRIPTION OF THE DRAWINGS

FIG. 1 is the general view of the system of our invention.

FIG. 2 is the view of the side units used in the system of our invention.

### REFERENCE NUMBERS

1. Mechanism
2. Rear base plate
3. Roller holder plate
4. Side unit
5. Roller
6. Spring
7. Locking plastic
8. Rivet
9. Screw
10. Nut
11. Damper
12. Rail

### DETAILED DESCRIPTION OF THE INVENTION

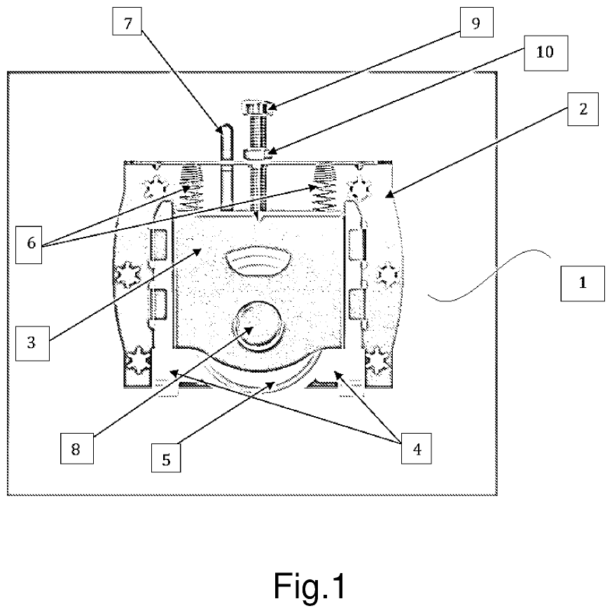

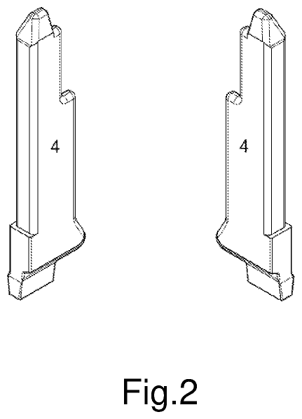

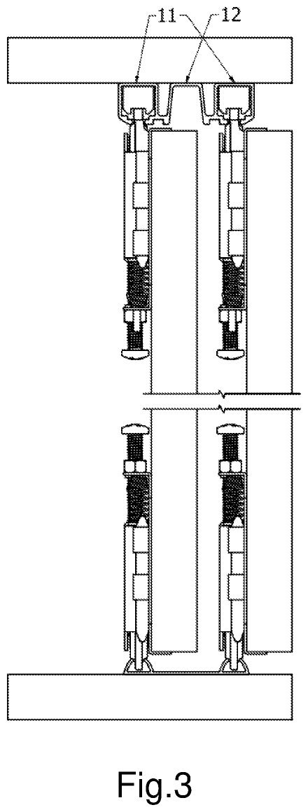

In this detailed description, the innovation of the invention is described only with the examples that do not have any limiting effect for a better understanding of the subject. Our invention is the sliding system comprising at least one rear base plate (2) that allows the furniture doors to move in a horizontal level and is fixed to the furniture doors, at least one roller holder plate (3) located on the stated rear base plate (2), at least one roller (5) that enables the furniture doors to open and close by sliding along a predetermined route, at least one rivet (8) that provides the centering and fixing of the stated roller(s) (5), the spring (6) that enables the roller(s) (5) carrying the furniture door to move to their predetermined positions after releasing the load, at least one screw (9) that allows the roller(s) (5) to stand at the predetermined height in order to balance the load of the doors, at least one nut (10) that enables the fixing of the screw (9), the locking plastic (7) that keeps the stated roller(s) (5) up in order to provide ease of assembly during the fitting of the furniture doors to the rail (12). In FIG. 1, general view of the system of our invention is given. Accordingly, the system comprises at least one side unit (4) that is placed in the rail (12) where the furniture doors are set, compatible with the concealed damper (11) invisible to the end user, in which the end parts are used as a damper (11) counterpart and that prevents noise and abrasion caused by friction.

In the preferred application of the system, the stated side units (4) is characterized as plastic. In the preferred application of the system, the stated rails (12) are aluminum profiles.

The operating principle of our invention is as follows:

In the sliding system developed with the invention, the function of the stated side units (4) is to provide ease in motion when the mechanism is assembled and to ensure that the mechanism (1) operates in a slower (11) manner with its structure compatible with the damper (11) placed in the rail (12).

In the present technique, in order to make a system operational with damper, there must be apparatus to set up the damper and catch it under the door. As a result of the design made in the system of our invention, the end parts of the side units (4) are designed to catch the damper (11). Therefore, there is no need for any additional damper apparatus in the system of our invention. Also, the damper (11) used is suitable for the rail (12). It can be coupled comfortably.

1. A sliding system that allows the furniture doors to move in a horizontal level, the sliding system comprising:
at least one rear base plate fixed to the furniture doors,
at least one roller holder plate located on said at least one rear base plate,
at least one roller that enables the furniture doors to open and close by sliding along a predetermined route,
at least one rivet that provides centering and fixing of said at least one roller,
a spring that enables the at least one roller carrying the furniture door to move to their predetermined positions after releasing the load,
at least one screw that allows the at least one roller to stand at the predetermined height in order to balance the load of the doors,
at least one nut that enables fixing of the screw,
a locking plastic that keeps said at least one roller up in order to provide ease of assembly during the fitting of the furniture doors to the rail,
characterized by further comprising:
at least one side unit that is placed in the rail where the furniture doors are set, compatible with a concealed damper invisible to the end user, in which the end parts are used as a damper counterpart and that prevents noise and abrasion caused by friction.

2. The sliding system according to claim 1, wherein said side unit is plastic.
